(19) United States
(12) Patent Application Publication
(10) Pub. No.: US 2003/0144027 A1
(43) Pub. Date: Jul. 31, 2003

(54) Method, system, and program product for telephony as means for communication with peripheral device

(76) Inventor: Antonio Rufus Uranga, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/056,815

(22) Filed: Jan. 25, 2002

(51) Int. Cl. H04M 1/00

(52) U.S. Cl. 455/557; 455/426

(57) ABSTRACT

In one embodiment, a peripheral device a connector communicating with a network and a controller communicating with the connector. Controller input signals are received from the network via the connector. Controller output signals are transmitted to the network via the connector. A portion of the controller output signals cause a communication path to be established between the controller and a mobile device.

### BACKGROUND OF THE INVENTION

The present invention relates to the peripheral device arts. It finds particular application in conjunction with communications between a peripheral device, which is used within a computing environment, and a mobile telephony device and will be described with particular reference thereto. It will be appreciated, however, that the present invention will also find application for communications between other devices and service operators.

Conventionally, all interactions between an electronic device (e.g., a peripheral device such as a printing device) and an operator (e.g., a user) have been performed via an interface. The interface is at least one of locally (e.g., directly) incorporated into the peripheral device (e.g., incorporated into the front panel) and remotely incorporated into a computing device communicating with the peripheral device. Consequently, remote maintenance and management methods for electronic devices are known in the art.

Traditional remote maintenance and management methods typically include a network (e.g., a local-area-network (LAN)), which communicates with both the electronic device and the remote computing device. If an error occurs within the printing device (e.g., the paper size/type called for in a print job is not available or a paper jam has occurred), the printing device transmits a signal indicative of the error (e.g., diagnostic information) to the network. The network transmits the signal to a server capable of being accessed by the remote management device (and an operator who accesses the remote management device). Optionally, the signal is transmitted to the server via an Internet. The remote management device interprets the signal and displays a corresponding message (e.g., an error message) to the remote management operator. Upon receiving the error message, the remote management operator takes appropriate action for correcting the error at the printing device.

Until now, the electronic device has only caused signals to be transmitted to, for example, a server, which stores the signals in the form of an electronic message (e.g., an e-mail message). The operator (e.g., an information technology support person) accesses the diagnostic electronic message from the server. One drawback to such electronic messaging is that the operator must be physically located at the peripheral device, his/her workstation, and/or some other device connected to the LAN (or the Internet) to access the electronic messages (e-mail messages). Consequently, a delay may occur between the time the electronic device causes the electronic message to be sent and the time when the operator retrieves and responds to the message.

The present invention provides a new and improved apparatus and method which overcomes the above-referenced problems and others.

### SUMMARY OF THE INVENTION

In one embodiment, a peripheral device includes a connector communicating with a network and a controller communicating with the connector. Controller input signals are received from the network via the connector. Controller output signals are transmitted to the network via the connector. A portion of the controller output signals cause a communication path to be established between the controller and a mobile device.

In another embodiment, a computer program product comprises a computer readable medium including computer readable program code means therein for causing a communication path to be established between a peripheral device and a mobile device via a gateway. Computer readable program code means determines an operating status of the peripheral device. Computer readable program code means generates a signal, as a function of the operating status of the peripheral device, for causing the communication path to be established.

In another embodiment, a method for establishing a communication path between a peripheral device and a mobile device determines an operating status of the peripheral device. A signal is generated, as a function of the operating status, for causing the communication path to be established.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 illustrates a component diagram of an exemplary system according to the present invention;

FIG. 2 illustrates a detailed component diagram of the telephony gateway according to the present invention;

FIG. 3 is an exemplary methodology of establishing a communication path in accordance with the present invention; and

FIG. 4 is an exemplary methodology of establishing a communication path in accordance with the present invention.

### DETAILED DESCRIPTION OF THE PREFERRED EMBODIMENTS

The following includes definitions of exemplary terms used throughout the disclosure. Both singular and plural forms of all terms fall within each meaning:

“Signal”, as used herein, includes but is not limited to one or more electrical signals, analog or digital signals, one or more instructions, a bit or bit stream, or the like.

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Firmware”, as used herein, includes but is not limited to computer readable program code (e.g., software) stored in at least one of read-only memory (ROM) and programmable ROM (PROM). In this sense, firmware is a of software and hardware, is often responsible for the behavior of a system when it is first switched on. A typical example of firmware is a “monitor” program in a microcomputer, which loads the full operating system from disk or from a network and then passes control to it.

The present system and method provides the capability for a peripheral device (e.g., a printing device), which communicates with a computing device, to notify a mobile telephony device (e.g., a mobile telephone, a cellular telephone, etc.) when an operating status indicates the peripheral device has entered into an error mode. As described in greater detail below, the peripheral device communicates with a first network (e.g., a local area network (LAN)), which, in turn, communicates with a telephony gateway included within a second network (e.g., the Internet). The telephony gateway communicates with a public switched telephone network (PSTN) (e.g., plain old telephone service (POTS)), which, in turn, communicates with the mobile telephony device.

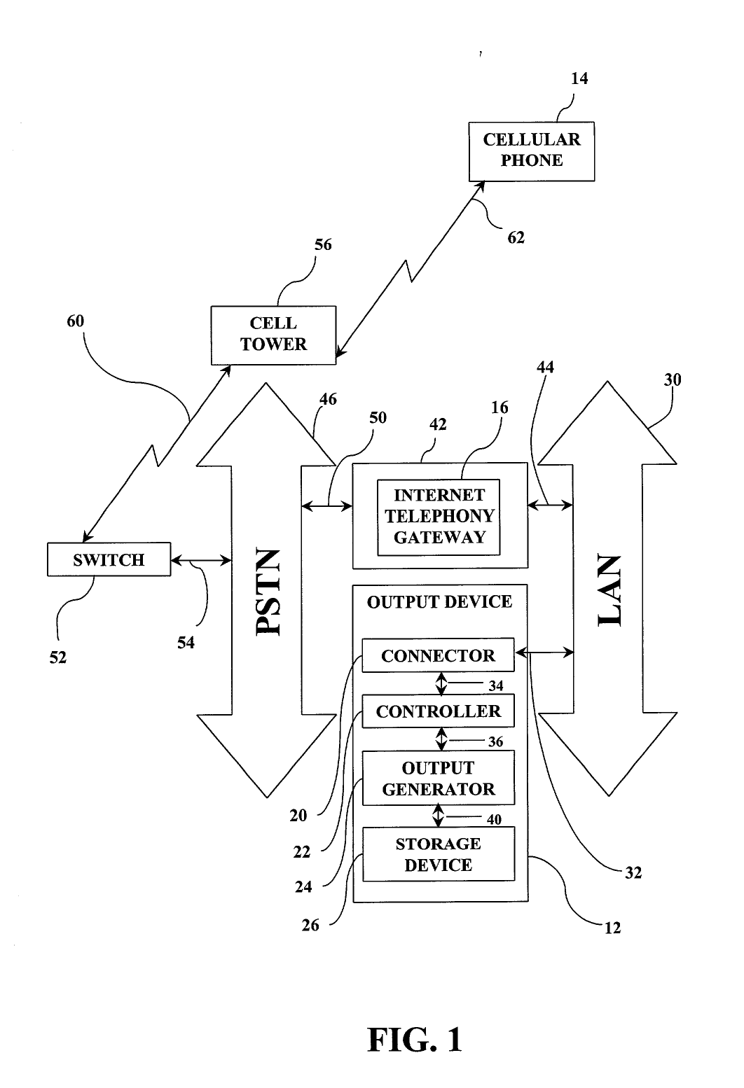

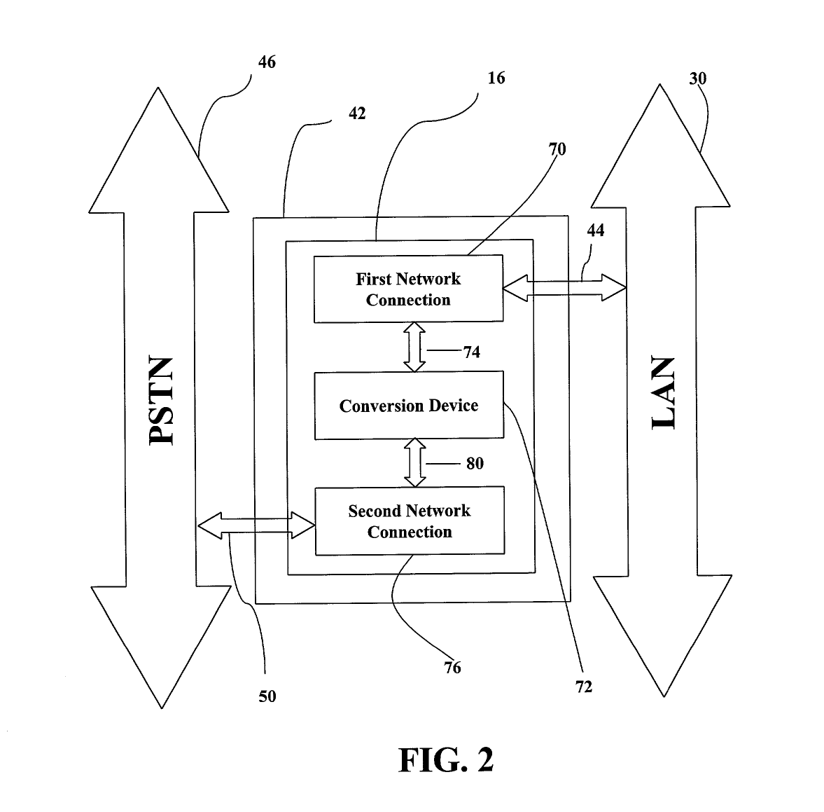

Illustrated in FIG. 1 is a simplified component diagram of an exemplary system 10 for causing a communication path to be created between a peripheral device 12 (e.g., an output device such as a printing device) and a mobile telephony device 14 via a telephony gateway 16. Illustrated in FIG. 2 is a detailed component diagram of the gateway 16. The peripheral device 12 includes a connector 20, a controller 22, a means for generating an output 24 (e.g., an output generator including a printing means (component) such as at least one of a laser printing component and an ink-jet printing component), and a computer readable medium 26 (e.g., a storage device). Furthermore, the peripheral device 12 communicates with a first network (e.g., a LAN) 30 via the connector 20 and a communication link 32. It is to be understood that the communication link 32 may or may not include a computing device (e.g., a personal computer (PC)). Within the peripheral device 12, the controller 22 communicates directly with the connector 20 and the output generator 24 via communication links 34, 36, respectively, and communicates indirectly with the computer readable medium 26 via the output generator 24 and a communication link 40.

The first network 30 communicates with a second network 42 (e.g., an Internet) via a communication link 44. The second network 42 includes the gateway 16, which communicates with a PSTN 46 via a communication link 50. The PSTN 46 communicates with a mobile tower switch 52 via a communication link 54, which communicates with a mobile tower 56 via a wireless means 60. Similarly, the mobile tower 56 is capable of communicating with the mobile telephony device 14 via a wireless means 62. It is to be understood that the wireless means 60, 62 typically incorporate radio-frequency signals; however, other wireless means of communication (e.g., infra-red signals and laser optical signals, etc.) are also contemplated.

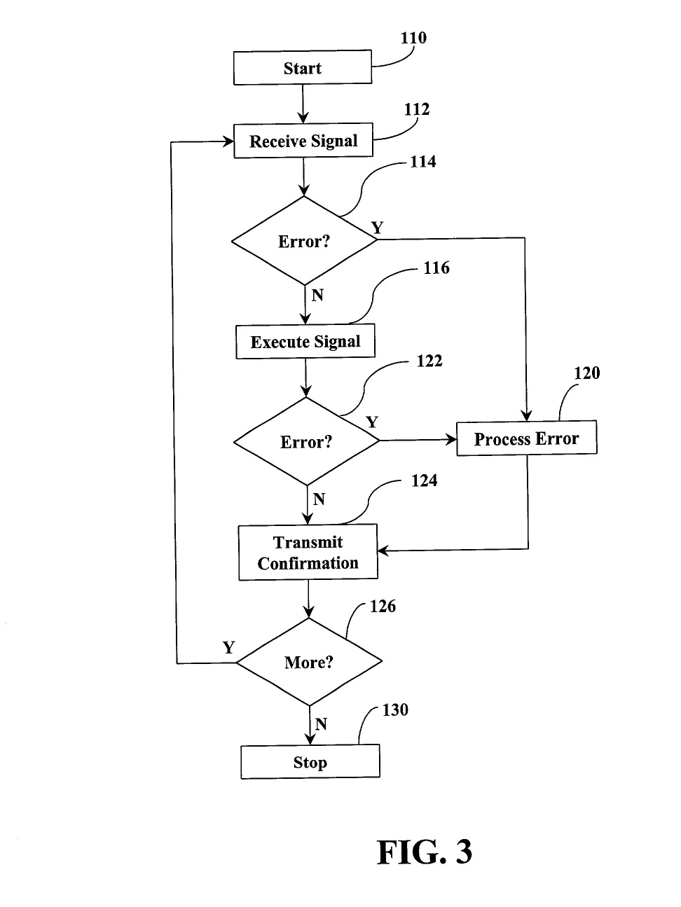

Illustrated in FIG. 3 is an exemplary methodology of the system shown in FIGS. 1 and 2 for causing a communication path to be created between the peripheral device 12 and the mobile telephony device 14. As illustrated, the blocks represent functions, actions and/or events performed therein. It will be appreciated that electronic, firmware, and software systems involve dynamic and flexible processes such that the illustrated blocks and described sequences can be performed in different sequences. It will also be appreciated by one of ordinary skill in the art that elements embodied as at least one of firmware and software may be implemented using various programming approaches such as machine language, procedural, object oriented or artificial intelligence techniques. It will further be appreciated that, if desired and appropriate, some or all of the at least one of firmware and software can be embodied as part of a device's operating system.

With reference to FIGS. 1-3, the process for causing the communication path between the peripheral device 12 and the mobile telephony device 14 starts in a block 110. The controller 22 within the peripheral device 12 receives a signal (e.g., a controller input signal) via, for example, the connector 20 from the first network 30 in a block 112. It is to be understood that the signal received in the block 112 may be intended to cause the peripheral device to perform a function. For example, the signal may be intended to cause the output generator 24 to generate an output (e.g., print on paper) or cause the controller to perform some other function (e.g., set a paper source for a print job, cancel a print job, and/or run a diagnostic test, etc). Furthermore, for purposes of explanation, the signal received in the block 112 represents only a single bit of data or single instruction for performing the function. Consequently, as described in more detail below, control returns to the block 112 for receiving subsequent bits of data and/or instructions for performing the function and future functions.

A determination is made, in a block 114, whether the operating status indicates the peripheral device 12 (e.g., at least one of the controller 22, the output generator 24, and the storage device 26) is in an error mode. The operating status is determined as a function of computer readable program code means (e.g., program product including at least one of software and firmware) included within the storage device 26 in the peripheral device 12. More specifically, the software and/or firmware monitors operations within at least one of the controller 22, the output generator 24, and the storage device 26 on a substantially continuous basis for determining whether the peripheral device 12 is in one of an “error” and “no-error” mode as a function of pre-programmed routines in the software/firmware.

If the peripheral device 12 is not in an error mode, control passes to a block 116; otherwise, control passes to a block 120 for processing the error. The blocks 116, 120 are described in more detail below.

The signal is executed in the block 116. For example, if the signal is intended to cause the peripheral device 12 to produce an output, the output is generated in the block 116; alternatively, if the signal is intended to perform some other function in the peripheral device 12, that function is performed in the block 116. A determination is made, in a block 122, whether the operating status indicates the peripheral device 12 is in an error mode.

If the peripheral device 12 is not in an error mode, control passes to a block 124 for transmitting a confirmation that the signal has been executed and that the controller is ready to receive a next signal. Control then passes to a block 126 for determining if additional signals are going to be transmitted to the controller 22. If more signals are going to be transmitted, control returns to the block 112 for receiving the next signal; otherwise, control passes to a block 130 for stopping the process.

If the peripheral device 12 is in an error mode, control passes to the block 120 for processing the error. Once the error is processed, control passes to the block 124 for transmitting a confirmation that the signal has been executed and that the controller is ready to receive a next signal. Then, control passes to the block 126 for determining if additional signals are to be received into the controller 22. If additional signals are to be received, control returns to the block 112; otherwise, control passes to the block 130 for stopping the process.

The blocks 114, 122 are included before and after the executing block 116 for determining the operating status of the peripheral device substantially immediately before and substantially immediately after the signal is executed. This sequence of blocks is intended to convey that the controller 22 is constantly monitoring the operating status of the peripheral device 12 and that control is passed to the block 120 substantially immediately after an error is detected.

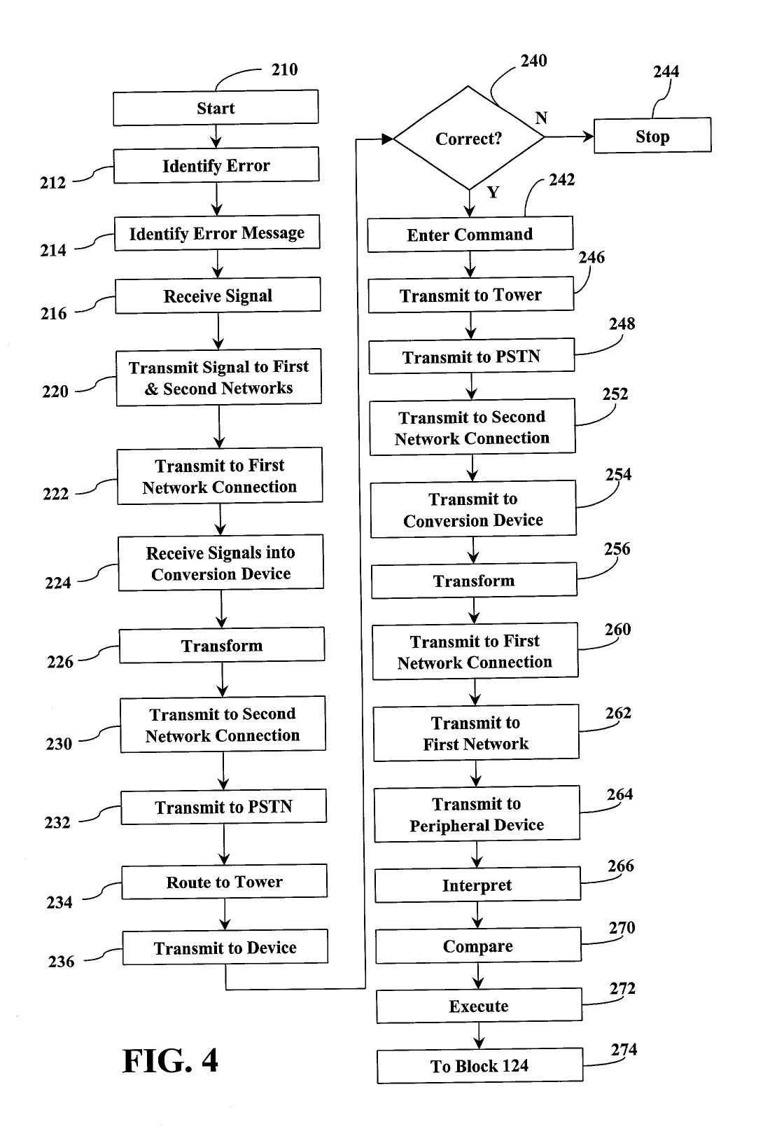

Illustrated in FIG. 4 is an exemplary methodology of the block 120 for processing an error. With reference to FIGS. 1, 2, and 4, the block 120 of processing the error starts in a block 210. The type of error is identified in a block 212. More specifically, the block 212 may determine that the error is associated with the output generator 24 (e.g., the paper size/type called for in a print job is not available (i.e., one of the paper trays is empty) or a paper jam has occurred). Once the type of error is identified, a corresponding error message (e.g., at least one of a voice message and a text message) is identified in a block 214. For example, if the error is identified in the block 212 as a paper jam, at least one of a corresponding voice message and text message, which convey the message that a paper jam has occurred (and optionally the location (e.g., paper tray) of the jam), is identified in the block 214. Alternatively, if the error is identified as a malfunction in the controller 22, at least one of a corresponding voice message and text message is identified in the block 214. It is to be understood that various voice and text error messages are stored in at least one of software and firmware included within the storage device 26 Although the storage device 26 is illustrated in FIG. 1 as being included within the peripheral device 12, other embodiments (e.g., in which the storage device 26 is not included within the peripheral device 12) are also contemplated.

Communication signals, which are stored in at least one of the software and the firmware, for establishing a communication path between the peripheral device 12 (e.g., the controller 22) and the mobile telephony device 14 are retrieved from the storage device 26 in a block 216. The communication signals are transmitted from the controller 22 to the mobile telephony device 14 via the connector 20, the first network 30, the gateway 16, the PSTN 46, switch 52, and tower 56. It is to be understood that the communication signals are retrieved from the storage device 26 and transmitted from the controller 22 to the mobile telephony device 14 as a function of the operating status of the peripheral device 12 (e.g., the operating statuses of at least one of the controller 22 and the output generator 24). In one example, the communication signals are in at least one of a packetized and digital format and identify a mobile telephony device (e.g., via a telephone number) to which the error message is to be sent.

The communication data is transmitted, in a block 220, from the peripheral device 12 to the first network 30 via the communication link 32 and from the first network 30 to the second network 42 via the communication link 44. From the second network 42, the communication data is transmitted, in a block 222, to a first network connection 70, which is included within the gateway 16. A conversion device 72 receives the communication signals from the first network connection 70, in a block 224, via a communication link 74. In a block 226, the conversion device 72 transforms the communication data into at least one of a de-packetized and analog format. The de-packetized and analog communication data is transmitted, in a block 230, from the conversion device 72 to a second network connection 76 (e.g., a telephony network connection) via a communication link 80. Then, the communication data is transmitted, in a block 232, to the PSTN 46 via the communication link 50.

The PSTN 46 routes the communication signal, in a block 234, to the mobile tower 56 (cell tower) via the switch 52. The tower 56 transmits, in a block 236, the communication signal to the mobile device 14. Upon receiving the communication signal, the mobile device 14 may notify a user (e.g., an Information Technology (IT) service person) that a message has been received. For example, a mobile telephony device may emit an audible, visual, or vibrational signal to alert the user to check for new messages. As discussed above, it is to be understood that the communication signal may represent at least one of a voice message and a text message. The message is delivered to the user via the mobile telephony device 14 when the user accesses (e.g., answers) the device 14.

Upon retrieving the message, the user determines, in a block 240, whether to take corrective action. Possible options available to the user include at least one of: a) transmitting a corrective instruction from the mobile telephony device 14 to the peripheral device 12 via the communication path between the mobile telephony device 14 and the peripheral device 12; and, b) physically relocating to the peripheral device 12 to correct the error (e.g., clear the paper jam). If the user determines to take corrective action, control passes to a block 242, which is discussed in more detail below. Otherwise, control passes to a block 244 for stopping the process. The blocks 242-274 describe the option of transmitting a corrective instruction from the mobile telephony device 14 to the peripheral device 12 via the communication path.

The user enters a command into the mobile telephony device, in the block 242, for attending to the error. It is contemplated that the command take various forms. For example, the command may be at least one of a voice command (i.e., the user may speak the command into the device 14) and a keyed command (i.e., the user may enter a command via a keypad on the mobile telephony device 14). Regardless of the form, a signal indicative of the corrective command (“the corrective command”) is transmitted, in a block 246, from the mobile telephony device 14 to the tower 56. Then, the signal is transmitted, in a block 248, from the tower 56 to the PSTN 46 via the switch 52. The corrective command signal is transmitted, in a block 252, from the PSTN 46 to second network 42 and the second network connection 76 in the gateway 16 via the communication link 50. Then, in a block 254, the corrective command is transmitted from the second network connection 76 to the conversion device 72, which, in a block 256, transforms the corrective command from at least one of a de-packetized and analog format into at least one of a packetized and digital format. The packetized and digital corrective command is transmitted, in a block 260, from the conversion device 72 to the first network connection 70 via the communication link 74. Then, the corrective command is transmitted, in a block 262, to the first network 30 via the communication link 44 and then to the peripheral device 12 (e.g., to the controller 22 via the connector 20) in a block 264. The corrective command is received in the controller 22 as a controller input signal.

The corrective command is interpreted in a block 266. More specifically, it is contemplated that various corrective commands for responding to various errors are stored in the storage device 26 (e.g., the at least one of the software and hardware). Furthermore, the corrective commands may be stored in various formats (e.g., at least one of voice format and telephone keypad generated (touch-tone) format). In the block 270, the corrective command is compared with the various corrective commands stored in the storage device 26. Once the corrective command is interpreted (i.e., identified), the corrective action associated with the command is executed in a block 272. For example, if the error code transmitted to the mobile telephony device 14 indicated the output medium (paper) size/type called for in a print job is unavailable (e.g., at least one of jammed and out of paper), the corrective command entered in the block 242 for attending to the error may cause the peripheral device 12 to instead use another size/type of output medium (e.g.,. draw the output medium from another tray in the peripheral device 12).

In a block 274, control passes to the block 124 (see FIG. 3).

It is to be understood that because the capability exists to transmit signals both a) from the peripheral device 12 to the mobile telephony device 14 and b) from the telephony device 14 to the peripheral device 12, at least one of bi-directional and real-time communication is possible between the peripheral device 12 and the mobile telephony device 14. Consequently, a remote user (e.g., an IT service person) is notified of an error condition that exists at the peripheral device 12 and may decide to take corrective action without physically relocating to the peripheral device 12.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiment, the invention is now claimed to be:

1. A peripheral device, comprising:
a connector communicating with a network; and
a controller communicating with the connector, controller input signals being received from the network via the connector, controller output signals being transmitted to the network via the connector, and a portion of the controller output signals causing a communication path to be established between the controller and a mobile device.

2. The peripheral device as set forth in claim 1, wherein the controller generates the portion of the output signals for establishing the communication path as a function of an operating status of the controller.

3. The peripheral device as set forth in claim 1, wherein the controller input signals include signals for causing an output to be generated, the peripheral device further including:
means for generating the output.

4. The peripheral device as set forth in claim 3, wherein the means for generating the output includes:
a printing component.

5. The peripheral device as set forth in claim 3, wherein the controller generates the portion of the output signals for establishing the communication path as a function of respective operating statuses of at least one of the means for generating the output and the controller.

6. The peripheral device as set forth in claim 1, wherein:
a format of the portion of the controller output signals is at least one of a) packetized and b) digital;
any of the portion of the controller output signals in the packetized format are converted to a de-packetized format for establishing the communication path between the controller and the mobile device; and
any of the portion of the controller output signals in the digital format are converted to an analog format for establishing the communication path between the controller and the mobile device.

7. The peripheral device as set forth in claim 6, wherein the portion of the controller output signals in the packetized format are converted to the de-packetized format and the portion of the controller output signals in the digital format are converted to the analog format in a gateway communicating with the network.

8. The peripheral device as set forth in claim 1, wherein a portion of the controller input signals are received from the mobile device via the communication path.

9. The peripheral device as set forth in claim 8, wherein:
any of the portion of the controller input signals transmitted from the mobile device in a de-packetized format are converted to a packetized format before being received by the controller;
any of the portion of the controller input signals transmitted from the mobile device in an analog format are converted to a digital format before being received by the controller.

10. The peripheral device as set forth in claim 9, wherein:
the portion of the controller input signals are received from the mobile device via a gateway;
any of the portion of the controller input signals are converted to the packetized format and the analog format within the gateway.

11. A computer program product comprising a computer readable medium including computer readable program code means therein for causing a communication path to be established between a peripheral device and a mobile device via a gateway, comprising:
computer readable program code means for determining an operating status of the peripheral device; and
computer readable program code means for generating a signal, as a function of the operating status of the peripheral device, for causing the communication path to be established.

12. The computer program product as set forth in claim 11, wherein:
the operating status of the peripheral device is one of “error” and “noerror”; and
if the operating status is “error”, the computer readable program code means generates the signal for causing the communication path to be established.

13. The computer program product as set forth in claim 11, wherein the computer readable program code means generates the signal having at least one of a packetized format and a digital format.

14. The computer program product as set forth in claim 13, wherein:
the gateway ensures the signal is in a de-packetized format and an analog format; and
the computer readable program code means generates the signal to include a mobile device identifier.

15. The computer program product as set forth in claim 11, further including:
computer readable program code means for interpreting a signal received from the mobile device.

16. A method for establishing a communication path between a peripheral device and a mobile device, the method comprising:
determining an operating status of the peripheral device;
generating a signal, as a function of the operating status, for causing the communication path to be established.

17. The method for establishing the communication path as set forth in claim 16, wherein the generating includes:
if the operating status indicates an error within the peripheral device, generating the signal for causing the communication path to be established.

18. The method for establishing the communication path as set forth in claim 16, further including:
transmitting the signal from the peripheral device to the mobile device via a gateway; and
within the gateway, ensuring the signal is in at least one of a de-packetized format and an analog format.

19. The method for establishing the communication path as set forth in claim 16, further including:
transmitting a second signal from the mobile device to the peripheral device via the gateway.

20. The method for establishing the communication path as set forth in claim 19, further including:
within the gateway, ensuring the signal is in at least one of a packetized format and a digital format.
